(19) United States
(12) Patent Application Publication
(10) Pub. No.: US 2023/0135266 A1
(43) Pub. Date: May 4, 2023

(54) Automatic Feeding Apparatus For An Aquarium

(71) Applicant: James A. Cox,, JR., Litchfield Park, AZ (US)

(72) Inventor: James A. Cox,, JR., Litchfield Park, AZ (US)

(21) Appl. No.: 17/515,499

(22) Filed: Oct. 31, 2021

(51) Int. Cl. A01K 61/85; A01K 63/04

(52) U.S. Cl. CPC A01K 61/85; A01K 63/047

(57) ABSTRACT

An apparatus for dispensing food to an aquarium includes a reservoir, a pump, and a draw line coupled between the reservoir and the pump to draw solution from the reservoir and pass the solution downstream to the pump. The draw line is routed through the pump. A supply line and return line are respectively configured to supply and return water from and to the aquarium. A mixing connection is downstream from the pump and couples the draw line with the supply and return lines. The reservoir, pump, draw line, supply line, return line, and mixing connection are all contained within a refrigerated compartment to keep the aquarium food from spoiling.

### FIELD

The present specification relates generally to aquariums, and more particularly to aquatic feeding systems.

### BACKGROUND

Keeping an aquarium is a popular hobby in the United States. Aquariums and the creatures living in them add a vibrant element to any home. The fish and coral in an aquarium bring color and motion to a room during the day and cast a magical glow at night. Aquariums are wonders enjoyed by ages young and old.

Maintaining an aquarium requires some effort, however. Typically, equipment must be purchased, water must be replaced, tanks must be cleaned. And, of course, the owner has to stock the aquarium with fish. These fish become pets, with characteristics and personalities that endear them to their owners.

Like many pets, aquarium fish are left at home when the owner travels. When an owner leaves home for the day, the fish are left home without worry. When an owner travels for a day or two, some fish can be fed in advance, without the need for a sitter to stop in and check on them. But prolonged trips require a different solution. Over-feeding the fish before the start of the trip is dangerous, as the fish can overeat at first and then starve later. Moreover, some types of fish food are kept frozen until they are delivered to the fish. Frozen fish foods must be fed to the fish or discarded; they cannot stagnate at room temperature or they will spoil. As such, there is no way to feed frozen food to the fish without having someone come to the house to manually feed the fish each time. An improved method for feeding fish is needed.

### SUMMARY

In an embodiment, an apparatus for dispensing food to an aquarium includes a reservoir, a pump, and a draw line coupled between the reservoir and the pump to draw solution from the reservoir and pass the solution downstream to the pump. The draw line is routed through the pump. A supply line and return line are respectively configured to supply and return water from and to the aquarium. A mixing connection is downstream from the pump and couples the draw line with the supply and return lines. The reservoir, pump, draw line, supply line, return line, and mixing connection are all contained within a refrigerated compartment to keep the aquarium food from spoiling.

In embodiments, the pump is a peristaltic pump. A stirrer is within the reservoir. A magnetic base is below the reservoir and is configured to create a rotating magnetic field to impart rotation to the stirrer in the reservoir. The stirrer includes an impeller. The reservoir includes a spout extending along a sidewall of the reservoir and having an open bottom coupled in fluid communication with the reservoir at a bottom of the reservoir. The draw line is applied to the spout to draw solution from the reservoir through the open bottom of the spout.

In an embodiment, an apparatus for dispensing food to an aquarium includes a refrigerated compartment containing and keeping cold a reservoir, a pump, a draw line extending from the reservoir, through the pump, to a mixing connection, a supply line extending from an inlet in the compartment to the mixing connection upstream from the draw line, and a return line extending from the mixing connection, downstream from the draw line, to an outlet in the compartment.

In embodiments, the pump is a peristaltic pump. A stirrer is within the reservoir and has an impeller. A magnetic base is below the reservoir which induces rotation to the stirrer in the reservoir. The reservoir includes a spout extending along a sidewall of the reservoir and has an open bottom coupled in fluid communication with the reservoir at a bottom of the reservoir. The draw line is applied to the spout to draw solution from the reservoir through the open bottom of the spout.

In an embodiment, an apparatus for dispensing food to an aquarium includes a refrigerated compartment including a door and an inlet and outlet in a wall of the compartment. The compartment contains a reservoir, a pump, a mixing connection downstream from the pump, a draw line extending from the reservoir, through the pump, to the mixing connection, a supply line extending from the inlet to the mixing connection, and a return line extending from the mixing connection to the outlet.

In embodiments, the pump is a peristaltic pump. A stirrer is within the reservoir. A magnetic base is below the reservoir and is configured to create a rotating magnetic field to impart rotation to the stirrer in the reservoir. The stirrer includes an impeller. The reservoir includes a spout extending along a sidewall of the reservoir and having an open bottom coupled in fluid communication with the reservoir at a bottom of the reservoir. The draw line is applied to the spout to draw solution from the reservoir through the open bottom of the spout.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a perspective view of an automatic feeding apparatus and an aquarium;

FIG. 2 is a perspective view of an interior of the automatic feeding apparatus showing a pump and a reservoir for holding a food solution to be dispensed to the aquarium;

FIG. 3 is a lower perspective view of the interior of the automatic feeding apparatus, with the reservoir removed, illustrating an underside of the pump; and

FIG. 4 is a side perspective of the pump and reservoir in isolation.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

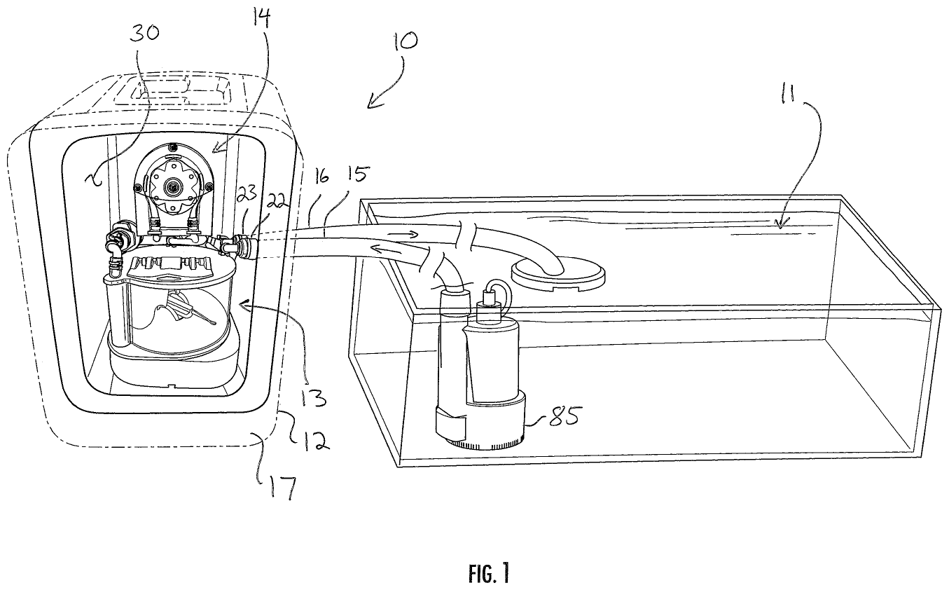

FIG. 1 illustrates an automatic feeding apparatus 10 for dispensing food to an aquarium 11. The apparatus 10 includes a refrigerated compartment 12, a reservoir 13 for holding food, and a pump assembly 14 for delivering the food to the aquarium 11 through a series of conduits. The apparatus 10 is coupled in fluid communication to the aquarium 11 with an exterior supply line 15 and an exterior return line 16.

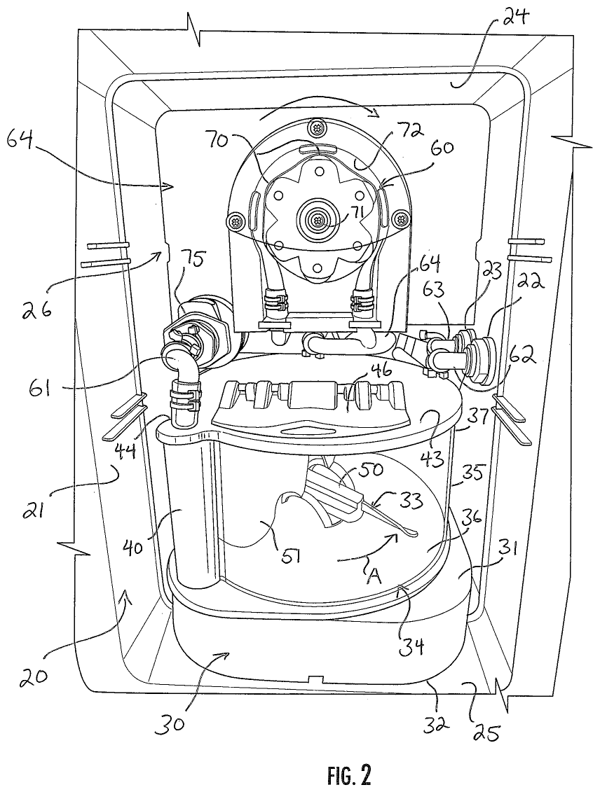

FIG. 2 illustrates the apparatus 10 in greater detail. An interior 20 of the refrigerated compartment 12 (hereinafter, the “compartment 12”) is shown. The interior 20 is bound and defined between walls 21 of the compartment 12 and a door 17 mounted to the front of the compartment 12. The door 17 is shown in a closed configuration on the front of the compartment 12 in FIG. 1 in broken line for transparency. The door 17 opens to provide access to the interior 20 of the compartment 12. In some embodiments, a small refrigerator can serve as the compartment 12. In other embodiments, the compartment 12 is custom-built for the apparatus 10. An inlet 22 and an outlet 23 are set into one of the walls 21. The inlet 22 and outlet 23 are both ports, sealed to the inner and outer surfaces of the compartment 12 to mitigate thermal transfer through the holes in which the inlet 22 and outlet 23 are set. On the outside of the compartment 12, the exterior supply line 15 couples to the inlet 22 and the exterior return line 16 couples to the outlet 23.

The interior 20 of the compartment has a flat top 24, a flat bottom 25, and a flat back 26 opposite the door 17. The reservoir 13 is on a base 30 resting on the bottom 25. The base 30 is a wide, short platform extending between a flat top 31 and parallel, flat bottom 32. The base 30 fits snugly between the walls of the compartment 12 and locates the reservoir 13 upon it centrally in the compartment 12. In embodiments, the flat top 31 has a central depression for receiving and seating the reservoir 13 with respect to the base 30, preferably in a registered disposition. In other embodiments, the flat top 31 is entirely flat and the reservoir 13 simply sits upon the top 31. In other embodiments, the reservoir 13 is integrally formed to the top 31 of the base 30.

The base 30 is a magnetic base which drives a magnetic stirrer 33 within the reservoir 13. Inside the platform of the base, a motor has an upstanding rotor containing a magnet. In some embodiments, the magnet is an elongate bipolar magnet, while in other embodiments, the magnet is offset from the rotor. Rotation of the motor establishes a rotating magnetic field, such that corresponding rotation is imparted on the magnetic stirrer 33, such as along the arcuate line A in FIG. 2. In other words, the magnetic base 30 induces rotation to the magnetic stirrer 33 despite a lack of physical contact with the stirrer 33.

The reservoir 13 sits upon the base 30 and is thus held within the compartment 12. The reservoir 13 includes a chamber 34 having a continuous sidewall 35 formed integrally to a bottom endwall 36, thereby defining a continuous, fluid impermeable hold for receiving and holding a liquid. In some embodiments, the chamber 34 is formed integrally to the base 30, such that the base 30 and the reservoir 13 are not separate. The sidewall 35 is preferably transparent or semi-opaque so that the contents of the chamber 34 are visible. The sidewall 35 extends upwardly to an open top 37.

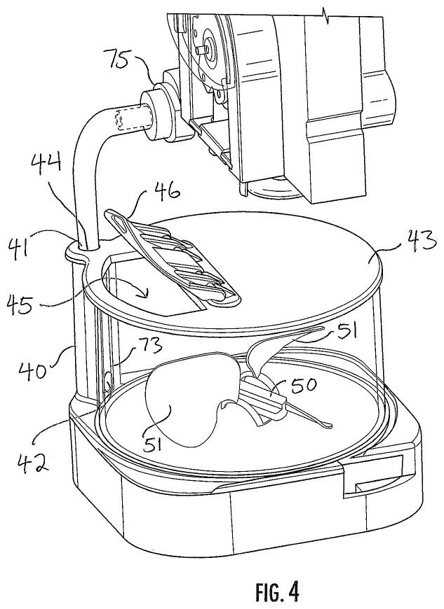

A spout 40 extends vertically alongside of the exterior of the sidewall 35 from the base 30 to the open top 37 of the sidewall 35. The spout 40 is a hollow cylinder formed integrally to the sidewall 35. The spout 40 has an open top 41 and an open bottom 42, as seen in FIG. 4. The open top 41 is parallel to and level with the open top 37 of the sidewall 35. The open bottom 42, however, is transverse to both: it is a hole or bore formed through the sidewall 35. The open bottom 42 couples the spout 40 to the chamber 34 in fluid communication. The spout 40 holds a draw line coupled to the pump assembly 14 so that the pump assembly 14 can draw fluid from the reservoir 13 without interfering with the operation of the stirrer 33.

A lid 43 is fit to the chamber 34. The lid 43 covers both the open top 37 of the sidewall 35 and the open top 41 of the spout 40. A bore 44 is formed through the lid 43 and is registered over the spout 40. The lid 43 has a large mouth 45 with a hinged flap 46 covering the mouth 45. The mouth 45 is large enough to place frozen fish food cubes through. The flap 46 closes to ensure there is no spillage out of the chamber 34 during mixing.

Food placed in the chamber 34 may be frozen, thawed, or partially thawed. Water may also be placed within the chamber 34, and if so, the food and water mixes to form a food solution. If not, the food thaws to form a food solution. The stirrer 33 within the chamber 34 mixes the food solution and ensures it is homogenous. The stirrer 33 has a central base 50 and two outwardly extending impellers 51. The impellers 51 are large fins projecting radially outwardly and upwardly from the base 50. The base 50 is elongate and magnetic, with opposed ends of preferably opposed magnetic polarity, such that the base 50 responds to the presence and movement of a magnetic field. When the motor within the base 30 spins to create a moving magnetic field, the base 50 responds and rotates as well. The stirrer 33 thus spins, and the impellers 51 move through and disturb the food solution. In this way, the food solution is mixed thoroughly.

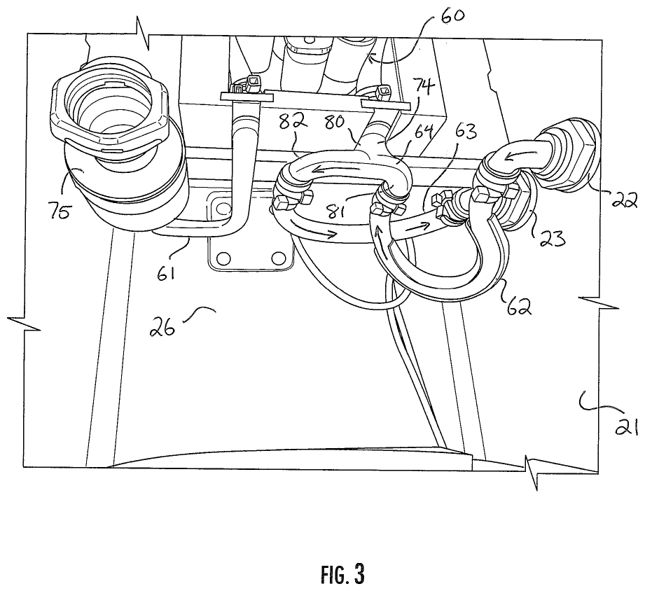

The pump assembly 14 draws the food solution from the chamber 34 and supplies it downstream to the aquarium 11. With reference to FIGS. 2 and 3 primarily, the pump assembly 14 includes a pump 60, a draw line 61, a supply line 62, a return line 63, and a mixing connection 64 between the draw, supply, and return lines 61, 62, and 63.

The pump 60 shown in this embodiment is a peristaltic pump. In other embodiments, the pump 60 is another kind of pump, such as a diaphragm pump or otherwise. The pump 60 here includes a number of rollers 70 mounted in circumferentially-spaced apart positions, all radially offset from a central drive shaft 71 driven by a motor. The motor is not shown in these illustrations but one having ordinary skill in the art will appreciate that the motor is an electric motor or the like, coupled to the drive shaft 71. The draw line 61 is routed around the pump 60, between the rollers 70 and a circumferential wall 72 for compression. As the motor operates to rotate the pump 60 in a clockwise direction, the rollers 70 sequentially compress portions of the draw line 61, thereby drawing fluid through the draw line 61. The spacing between the rollers 70 causes the pump 60 to draw discrete amounts of fluid, and by timing the rotational speed of the pump 60, the amount of drawn fluid can be determined and thus controlled.

The draw line 61 is disposed within the reservoir 13, so that operation of the pump 60 draws food solution up from the chamber 34. The draw line 61 has an upstream end 73 and an opposed downstream end 74. The upstream end 73 is shown in FIG. 4; it is disposed in the spout 40 proximate the open bottom 42 thereof. The upstream end 74 is thus proximate to and disposed in fluid communication with the bottom of the chamber 34 where it can draw food solution therefrom. The draw line 61 then extends up from the upstream end 74, through the spout 40, through the bore 44 in the lid 43 and then up above the reservoir 13. In the embodiment shown here, the draw line 61 makes a ninety-degree bend and is then fit in a coupling 75. The coupling 75 is an optional feature and allows the draw line 61 to be broken so that the reservoir 13 and pump assembly 14 can be easily separated. The draw line 61 continues from the coupling 75 and is routed through the pump 60, between the rollers 70 and the wall 72. In the embodiment shown herein, a separate but connected line actually is routed through the pump 60, and the draw line 61 is coupled thereto, but that separate line constitutes part of the draw line 61 and in some embodiments is an integral portion thereof. The draw line 61 terminates at the downstream end 74, which is coupled to the mixing connection 64. The mixing connection 64 is thus downstream from the pump 60.

Referring to FIG. 3 primarily, the supply and return lines 62 and 63 also terminate at the mixing connection 64. The supply line 62 is relatively short. It is coupled to the inlet 22 in the wall 21 of the compartment 12. The supply line 62 is thus joined in fluid communication to the external supply line 15 and supplies water from the aquarium 11 to the apparatus 10. The supply line 62 extends from the inlet 22 to the mixing connection 64. Similarly, the return line 63 is short, extending from the mixing connection 64 to the outlet 23 in the wall 21. The return line 63 is joined in fluid communication to the external return line 16 to return water to the aquarium 11 from the apparatus 10.

The mixing connection 64 mixes water from the aquarium 11 with food solution from the chamber 34. The mixing connection 64 is a wye with three ports 80, 81, and 82. As used in this apparatus, two ports 80 and 81 are upstream or inlet ports and one port 82 is a downstream or outlet port. The draw line 61 is coupled to one of the inlet ports 80, and the supply line 62 is coupled to the other inlet port 81. As such, food solution is supplied to the mixing connection 64 through the inlet port 80 and aquarium water is supplied to the mixing connection 64 through the inlet port 81. The return line 63 is coupled to the outlet port 82. The mixture of water and food solution communicates from the mixing connection 64 through the outlet port 82 and downstream through the return line 63 to the aquarium 11.

In some embodiments, the apparatus is timer-or computer-controlled. In timer-controlled embodiments, the base 30 and the pump assembly 14 are each coupled in electronic control to a timer in the apparatus 10. A submersible pump 85 in the aquarium is also coupled to the timer. The timer activates the motor in the base 30 to rotate the magnetic stirrer 33 and activates the pump assembly 14 to draw and dispense food solution. The user can program the timer to operate at certain times of the day.

In computer-controlled embodiments, the apparatus 10 includes an onboard programmable logic controller or like computing device. In embodiments, the user can directly program the logic controller. In other embodiments, the user can interact with a GUI on the apparatus 10 to program the apparatus 10. In other embodiments, the logic controller is coupled in wireless data communication with a server, and the user can program the apparatus 10 with an online portal or a mobile application. In still other embodiments, the logic controller is coupled in wireless data communication, such as Bluetooth or Zigbee, with a mobile application. With any of these embodiments, the user is able to program the timer to instruct the apparatus to start and stop each of the pump 60, the submersible pump 85, and the magnetic stirrer 33. In some embodiments, the user can program the operating time while in other embodiments, he programs the amount of food solution to be dispensed.

The logic controller is connected in electronic communication with the base 30 and the pump assembly 14 to start and stop operation of each. The logic controller thereby can initiate rotation of the stirrer 33 for a predetermined period, wait for the food solution to become homogenized, and then instruct the pump assembly 14 to operate to draw food solution up from the chamber 34 to be mixed with water from the aquarium 11. The logic controller is also coupled in electronic communication with the submersible pump 85 in the aquarium 11 to initiate operation of the pump 85 such that it selectively supplies water to the apparatus 10. Preferably, the pump 85 operates to not only supply water through the supply lines 15 and 62 to mix with the frozen food from the chamber 34, but also to rinse the frozen food from the mixing connection 64 and the return line 63 after the food solution has been dispensed. In the latter situation, the pump 85 pumps water through the supply lines 15 and 62 so that such water can simply cycle back and return to the aquarium through the return lines 63 and 16.

In operation, the apparatus 10 is useful to automatically mix and dispense a food solution to an aquarium 11. The owner of the aquarium 11 may use the apparatus 10 to automate feeding while he is away, but the apparatus 10 is equally useful for automated feeding even when the owner is home.

To use the apparatus 10, the owner first places the apparatus 10 in a location sufficiently close to the aquarium 11 such that both the external supply and return lines 15 and 16 can reach into the aquarium 11. The owner places the ends of those lines 15 and 16 into the aquarium 11, ensuring that the end of the supply line 15 is securely coupled to the submersible pump 85 so that it can pump water through the line 15.

The owner then readies the compartment 12. First, the owner ensures the interior 20 of the compartment 12 is cooled. The interior 20 is preferably maintained at a temperature just above freezing, to allow food kept within the reservoir 13 to thaw but also to prevent it from spoiling. Once the interior 20 is cooled to the desired temperature, the owner can place the food therein.

Opening the door 17 of the compartment 12, the owner can remove the reservoir 13 or leave it in place within the interior 20 while he adds food. If the owner desires to remove the compartment 12, he first disconnects the draw line 61 from the coupling 75 before lifting the reservoir 13 off the base 30. In embodiments in which the reservoir 13 and the base 30 are an integral unit, the owner simply lifts the reservoir 13 and base 30 out together.

The owner next lifts the flap 46 in the lip 43 of the reservoir 13. The lifted flap 46 exposes the mouth 45. The owner drops the frozen food through the mouth 45, which is large enough to allow the food to pass through even in solid state. Sometimes, this is all the owner need do. He closes the flap 46, puts the reservoir 13 back in the interior 20, and closes the door 17 of the compartment 12. Other times, the owner may wish to dilute the food. He does so by adding water through the open mouth 45, then closes the flap 46 and replaces the reservoir 13 in the compartment 12. Still other times, the owner may wish to thaw the frozen food slightly. He can thaw the food and place it in the chamber 34. Thawing the food before placing it in the chamber 34 assures the owner that the food will definitely not be frozen when the apparatus 10 attempts to dispense it to the aquarium 11. The owner can thaw the food with or without additional water for dilution.

After the owner returns the reservoir 13 to the interior 20 of the compartment 12, he closes the door 17. He sets the timer or programs the programmable logic controller for desired times, durations, or metered amounts to dispense the food solution. After finishing this, the owner can leave the apparatus 10 to run.

When the time comes for the apparatus 10 to dispense, the motor in the base 30 begins to rotate. This creates a rotating magnetic field. The magnetic stirrer 33 rotates in response to creation of the rotating magnetic field. The stirrer 33 spins, and the impellers 51 mix the food solution. The motor rotates for a predetermined time deemed sufficient to mix the food solution into homogeneity.

Once that mixing time has passed, the pump 60 begins moving. The stirrer 33 preferably, but not necessarily, continues to operate while the pump 60 is active. The pump 60 rotates, drawing food solution up the draw line 61 from the bottom of the chamber 34. The food solution passes through the portion of the draw line 61 routed through the pump 60, where the rollers 70 impinge the draw line 61 to cause the movement of the food solution. Exiting the pump 60, the food solution leaves the draw line 61 and enters the mixing connection 64, where it mixes and dilutes with water supplied by the pump 85 in the aquarium. The diluted food solution then travels out the outlet port 82 of the mixing connection 64, through the return line 63, through the outlet 23 in the wall 21, and back through the external return line 16 to the aquarium 11, thereby providing food to the aquarium 11 habitat.

The pump 60 continues to operate for a predetermined time, as set by the owner. This time may be sufficient to draw all food solution from the reservoir 13. Alternatively, this time may be sufficient to draw only a portion of the food solution from the reservoir 13. In the latter situation, the food solution remaining in the reservoir 13 is held until the next scheduled feeding. The compartment 12 keeps the remainder food solution cool so that it does not spoil before the next feeding.

Regardless of whether the food solution in the chamber is depleted or not, the apparatus 10 preferably undergoes a cleaning cycle after each dispensation. This helps maintain the cleanliness and reliable operation of the apparatus 10. To run the cleaning cycle, the apparatus 10 instructs the submersible pump 85 to run while the peristaltic pump 60 does not run. The pump 85 draws water from the aquarium 11, pumps it through the external supply line 15, through the supply line 62 within the compartment 12, through the mixing connection 64, and then out the return lines 63 and 16 back to the aquarium 11. This allows clean aquarium water to flush out most of the tubing in the apparatus 10 to remove any food products left behind.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. An apparatus for dispensing food to an aquarium, the apparatus comprising:
a reservoir;
a pump;
a draw line coupled between the reservoir and the pump to draw solution from the reservoir and pass the solution downstream to the pump, the draw line routed through the pump;
a supply line and a return line, respectively configured to supply and return water from and to the aquarium; and
a mixing connection downstream from the pump, the mixing connection coupling the draw line with the supply and return lines;
wherein the reservoir, pump, draw line, supply line, return line, and mixing connection are all contained within a refrigerated compartment.

2. The apparatus of claim 1, wherein the pump is a peristaltic pump.

3. The apparatus of claim 1, further comprising a stirrer within the reservoir.

4. The apparatus of claim 3, further comprising a magnetic base below the reservoir configured to create a rotating magnetic field to impart rotation to the stirrer in the reservoir.

5. The apparatus of claim 4, wherein the stirrer includes an impeller.

6. The apparatus of claim 1, wherein the reservoir includes a spout extending along a sidewall of the reservoir and having an open bottom coupled in fluid communication with the reservoir at a bottom of the reservoir.

7. The apparatus of claim 6, wherein the draw line is applied to the spout to draw solution from the reservoir through the open bottom of the spout.

8. An apparatus for dispensing food to an aquarium, the apparatus comprising:
a refrigerated compartment containing and keeping cold:
a reservoir;
a pump;
a draw line extending from the reservoir, through the pump, to a mixing connection;
a supply line extending from an inlet in the compartment to the mixing connection upstream from the draw line; and
a return line extending from the mixing connection, downstream from the draw line, to an outlet in the compartment.

9. The apparatus of claim 8, wherein the pump is a peristaltic pump.

10. The apparatus of claim 8, further comprising a stirrer within the reservoir having an impeller.

11. The apparatus of claim 10, further comprising a magnetic base below the reservoir which induces rotation to the stirrer in the reservoir.

12. The apparatus of claim 8, wherein the reservoir includes a spout extending along a sidewall of the reservoir and having an open bottom coupled in fluid communication with the reservoir at a bottom of the reservoir.

13. The apparatus of claim 12, wherein the draw line is applied to the spout to draw solution from the reservoir through the open bottom of the spout.

14. An apparatus for dispensing food to an aquarium, the apparatus comprising:
a refrigerated compartment including a door and an inlet and outlet in a wall of the compartment, the compartment containing:
a reservoir;
a pump;
a mixing connection downstream from the pump;
a draw line extending from the reservoir, through the pump, to the mixing connection;
a supply line extending from the inlet to the mixing connection; and
a return line extending from the mixing connection to the outlet.

15. The apparatus of claim 14, wherein the pump is a peristaltic pump.

16. The apparatus of claim 14, further comprising a stirrer within the reservoir.

17. The apparatus of claim 16, further comprising a magnetic base below the reservoir configured to create a rotating magnetic field to impart rotation to the stirrer in the reservoir.

18. The apparatus of claim 17, wherein the stirrer includes an impeller.

19. The apparatus of claim 14, wherein the reservoir includes a spout extending along a sidewall of the reservoir and having an open bottom coupled in fluid communication with the reservoir at a bottom of the reservoir.

20. The apparatus of claim 19, wherein the draw line is applied to the spout to draw solution from the reservoir through the open bottom of the spout.
